(19) United States
(12) Patent Application Publication
(10) Pub. No.: US 2003/0233485 A1
(43) Pub. Date: Dec. 18, 2003

(54) Event queue

(75) Inventor: Salahuddin J. Khan, Redmond, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Mircrosoft Corporation, Redmond, WA

(21) Appl. No.: 10/170,759

(22) Filed: Jun. 13, 2002

(51) Int. Cl. G06F 9/46

(52) U.S. Cl. 709/318

(57) ABSTRACT

A novel system and method provide for event management utilizing a single thread or a limited plurality of threads to service queued events. When it is desired to add an event to the event queue, a thread is scheduled or acquired, such as from a thread pool, to service queue events unless such a thread is already active, or unless the current number of such threads equals or exceeds a preset thread limit when multiple threads are permitted. The use of a single thread, or alternatively a limited number of threads, to service the event queue leads to economy of system resources, and also avoids memory overflow due to thread proliferation. The limitation on the number of threads created to handle queued events assists in the avoidance of memory overflow complications. In addition, the elimination of threads that would otherwise occupy memory without providing substantial immediate results conserves system resources.

This invention relates generally to the technology of event management and, more particularly, relates to a system and method for queuing and servicing events without thread proliferation.

### BACKGROUND OF THE INVENTION

Computers and computing devices have grown in sophistication to the point that they can execute many tasks simultaneously. For example, word processing programs may check the spelling of written words in a manner that appears to be concurrent with the typing of words. Similarly, a single computer can support the apparently simultaneous execution of multiple applications. In truth, such apparently simultaneous processing is often a result of the running of multiple threads. A thread represents a distinct flow of control in a program. On a machine having multiple CPUs, the number of threads running in parallel can generally not exceed the number of processors. However, the machine may give the appearance of running a greater number of threads by allowing threads to share the resources of the processors on a time-divided basis.

Threads are sometimes used in computer programming to manage events. In particular, each pending event will typically be associated when created with a thread that terminates once the event and all appropriate notifications, etc., are concluded. While this allows for simple implementations, it does not foster either accuracy or efficiency. For example, in multiprocessor environments, the simultaneous use of multiple threads may result in the execution of tasks or servicing of events in an incorrect order. More significantly, whether used in a single threaded environment or a multithreaded environment, the association of a dedicated thread with each outstanding task, such as an event, leads to excessive thread proliferation. In some situations, the number of threads created in this manner can shut down an application due to stack overflow, and in any case, it represents an inefficient allocation of computational resources.

For example, in an environment wherein multiple extant threads are addressed serially one after the other, the very existence of threads that are not being addressed can be seen in most cases to be wasteful. Typically a thread is allocated a particular amount of memory in which to work, regardless of whether and to what extent the thread makes use of that memory. A non-active thread thus essentially preempts the allocated memory when it may be more efficient to yield the memory to another task. Moreover, the allocation of memory for threads may exceed, or attempt to exceed, the amount of memory that is allocatable to such threads, thus causing error and likely shutdown of the offending application or program.

A system and method of event management is needed whereby events are serviced in an orderly manner that does not waste system resources.

### SUMMARY OF THE INVENTION

A novel system and method are described for event management wherein a single thread or a limited plurality of threads are used to service queued events. The event queue is maintained and serviced in a first-in, first-out manner, queued events being serviced as their turn arises. The queue may be deconstructed when there are no further events awaiting servicing, or at any other time as needed via a shutdown handle.

Initially, the state of the queue is checked to determine whether there exist any events to be serviced. If there are none, or if the relevant service is shutting down, then the queue may be deconstructed according to an embodiment of the invention. Otherwise, a thread is scheduled or acquired, such as from a thread pool, to service queue events if no such thread already exists, or, when multiple threads are permitted, when the current number of such threads does not equal or exceed a preset thread limit. The use of a single thread, or alternatively a limited number of threads, to service the event queue leads to economy of system resources, and also avoids memory overflow due to thread proliferation. That is, the number of threads created to handle queued events will be limited and thus will not be permitted to cause overflow problems. In addition, the elimination of many threads that would otherwise occupy memory without providing substantial immediate results serves to save system resources, even when overflow is not a danger.

Data structures facilitate the operation and servicing of the queue in a manner consistent with embodiments of the invention as will be described in greater detail hereinafter. In an embodiment of the invention, a client list is provided in addition to the queue structure itself. In addition, a set of auxiliary structures may be provided to facilitate queue management in an embodiment of the invention.

Other features and advantages of various embodiments of the invention will become apparent from the detailed description set forth hereinafter.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an exemplary computer system usable in an implementation of an embodiment of the invention;

FIG. 2 is a schematic diagram showing the computational components related to event queuing and their interrelationships according to an embodiment of the invention;

FIG. 3A is an architectural diagram showing a client listing usable within an embodiment of the invention;

FIG. 3B is an architectural diagram showing an event queue and event handler thread according to an embodiment of the invention;

FIG. 3C is an architectural diagram showing auxiliary data structures usable within an embodiment of the invention to facilitate event handling;

FIG. 4 is a flow chart describing the steps taken to enqueue an event in the event queue according to an embodiment of the invention;

FIG. 5 is a flow chart describing the steps taken to enqueue an event in the event queue according to an alternative embodiment of the invention; and

FIG. 6 is a flow chart describing the steps taken to dispatch an event from the event queue according to an embodiment of the invention.

### DETAILED DESCRIPTION OF THE INVENTION

The invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Those skilled in the art will appreciate that the invention may be practiced with other computer system configurations, including hand-held devices, multiprocessor systems, microprocessor based or programmable consumer electronics, network PCs, minicomputers, mainframe computers, and the like. The invention may further be practiced in distributed computing environments wherein tasks are performed by remote processing devices that are linked through a communications network. In such a distributed computing environment, program modules may be located in both local and remote memory storage devices.

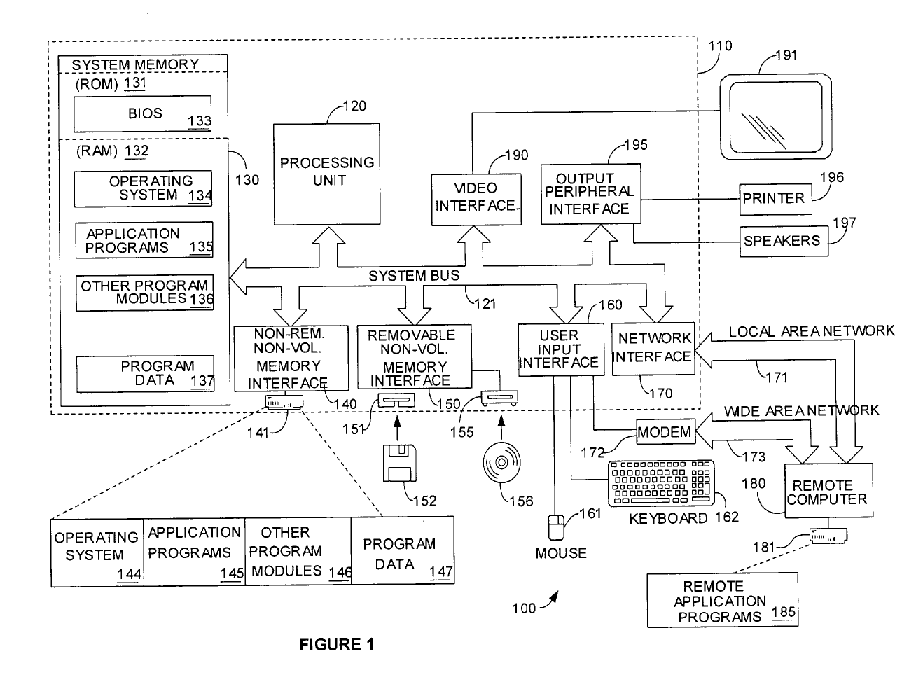

FIG. 1 illustrates an example of a suitable computing system environment 100 usable in an implementation of the invention. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be implemented by way of numerous other general purpose or special purpose computing system environments or configurations. Examples of well known computing systems, environments, and/or configurations that are suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

An exemplary system for implementing the invention includes a general-purpose computing device in the form of a computer 110. Components of the computer 110 generally include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example only, and not limitation, such architectures include Industry Standard Architecture (ISA) bus, Micro Channel Architecture (MCA) bus, Enhanced ISA (EISA) bus, Video Electronics Standards Associate (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, and removable and non-removable media. By way of example only, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics (such as, for example, voltage or current level, voltage or current pulse existence or nonexistence, voltage or current pulse width, voltage or current pulse spacing, etc.) set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates RAM 132 as containing operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a keyboard 162, pointing device 161 (commonly referred to as a mouse), and trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A dedicated monitor 191 or other type of display device may also be connected to the system bus 121 via an interface, such as a video interface 190. In addition to the monitor, computer 110 may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a router, a network PC, a peer device or other common network node, and in any case the remote computer or computers typically include many or all of the elements described above relative to the personal computer 110, although only a memory storage device 181 has been illustrated in FIG. 1, and although in some cases the remote computer can lack much of the functionality contained in the computer 110. The logical connections depicted in FIG. 1 include a local area network (LAN) 171 and a wide area network (WAN) 173, but the computer 110 may additionally or alternatively use one or more other networking environments. For example, the computer 110 may reside on an ad hoc network via a communications interface such as a wireless interface. Networking environments of all types are commonplace in offices, enterprise-wide computer networks, intranets and the Internet.

The computer 110 should include facilities for accessing the networks to which it is attachable. For example, when used in a LAN networking environment, the personal computer 110 is connected to the LAN 171 through a network interface or adapter 170. Another node on the LAN, such as a proxy server, may be further connected to a WAN such as the Internet. When used in a WAN networking environment, the computer 110 typically includes a modem 172 or other means for establishing communications directly or indirectly over the WAN 173, such as the Internet. The modem 172, which may be internal or external, may be connected to the system bus 121 via the user input interface 160, or other appropriate mechanism.

In a networked environment, program modules depicted relative to the personal computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used. When the invention is implemented in a networked environment, it is not intended to limit the invention to use in a permanent network infrastructure, since it may also be used in transiently connected environments, such as for example a wholly or partially wireless network environment interconnected wholly or partially via optical, infrared, and/or radio frequency wireless connections.

Herein, the invention is described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

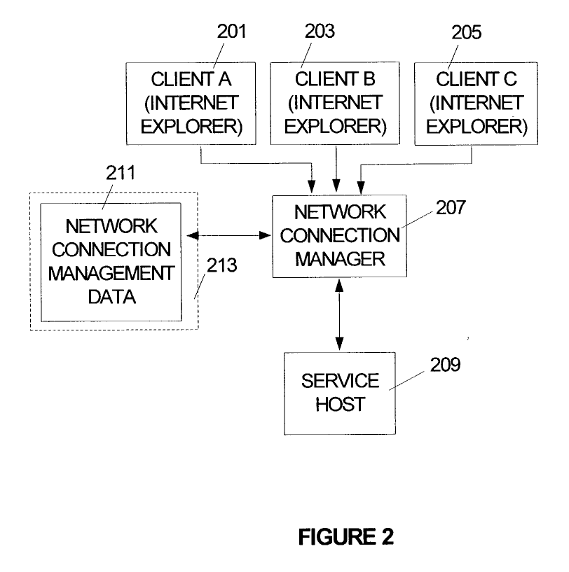

Although the described embodiments focus largely on the management of network events, it will be appreciated that the disclosed innovations may be used for the management of any event type. FIG. 2 illustrates schematically a computing environment within which the present invention may be implemented. The environment shown in FIG. 2 includes multiple network clients including client A (201), client B (203) and client C (205). Although three clients are shown, no numerical requirement or limitation is thereby imparted. A greater or fewer number of clients may be present without departing from the scope of the invention. Each client 201, 203, 205 represents an executing application, shown in the figure as the network application INTERNET EXPLORER by MICROSOFT CORPORATION of Redmond, Wash. Each client manages network events via services of the network connection manager 207. It will be appreciated that the clients 201-205 need not be the same, or even of the same type. Within an embodiment of the invention, the network connection manager 207 is a network connection manager dynamic linked library, which may be invoked by another process such as a service host process 209 (e.g., Svchost.exe). The network connection manager dynamic linked library 207 provides a controlling mechanism for all network connections managed by the host. Svchost.exe is a generic host process name for services that are run from dynamic-link libraries, and there may be multiple instances of Svchost.exe running at the same time. Each Svchost.exe session relates to a group of services, such that separate services can be run depending on how and where Svchost.exe is started. The network connection manager 207 notifies the clients 201, 203, 205 of relevant network events such as disconnection of a network connection, new connection of a network connection, and so forth as will appreciated by those of skill in the art. The network connection manager 207 manages network connections based on the use of management data 211, stored in a contiguous or noncontiguous memory space 213 accessible by the process. The memory space 213 may be RAM or ROM or any other computer-readable memory type, as such types were discussed with respect to FIG. 1.

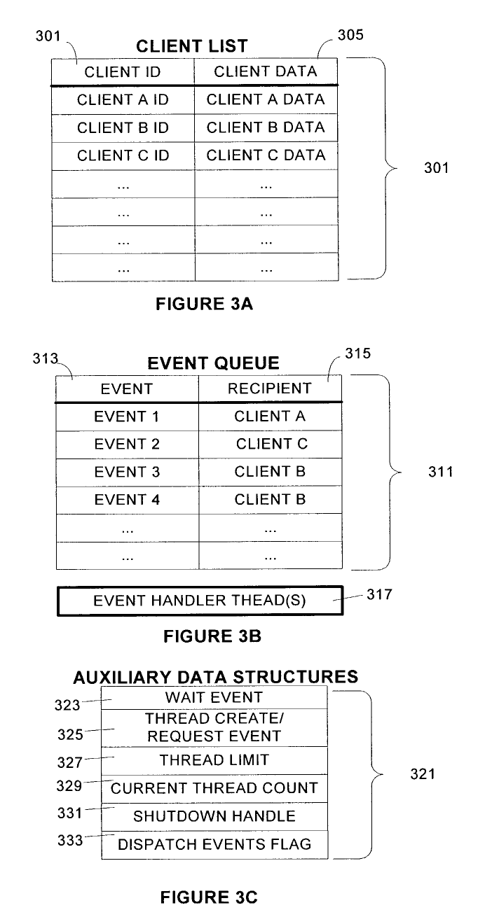

The tabular diagrams of FIGS. 3A-3C illustrate in greater detail the management data configurations that may be available to the network connection manager 207. In particular, FIGS. 3A-3C show exemplary structures within memory space 213 usable by the network connection manager 207 to manage network connections and to service network events. FIG. 3A shows a list 301 of clients that are associated with the network connection manager 207, and for which the connection manager 207 manages network events. The list of clients includes an entry 303 identifying each client, and may also include separate entries 305, each associated with a client identifier entry 303, for maintaining other client-specific information such as client status and so forth.

An exemplary event queue 311 usable by the network connection manager 207 to manage network events for the clients 201, 203, 205 is shown in FIG. 3B. The event queue 311 may hold any amount of information regarding pending events, such as those not yet dispatched, but preferably includes at least an event descriptor field 313 and an event notification recipient field 315. The event descriptor field 313 contains information regarding the nature of the event to managed, while the event notification recipient field 315 identifies the client or other entity or process to which notification regarding the associated event is to be sent. Each entry in the event notification recipient field 315 is thus associated with one entry in the event descriptor field 313.

The event queue 311 is an efficient structure for managing events in that, as discussed in greater detail below, the queue 311 is not instantiated until there is at least one item to place in the queue 311, and when there are no more items in the event queue 311 (or to be placed in the queue 311), the queue 311 is deleted. The order of the event listings in the queue 311 preferably sets the order in which the events will be managed. In particular, the queue servicing follows a first-in, first-out model rather than the first-in, last-out model often used in stacks. Furthermore, as will be described in greater detail hereinafter, the queue 311 is serviced in an embodiment of the invention by a single event handler thread 317 that is scheduled when an item is first placed in the queue 311, and which is terminated when there remain no further events in the queue 311 to service. In an embodiment of the invention, a limited plurality of threads 317 are used in place of a single thread 317 to service the queue 311. Note that the thread or threads 317 may be taken from the thread pool if available, or may instead be specifically created.

A collection 321 of auxiliary data structures such as that shown by way of example in FIG. 3C is preferably available to the network connection manager 207 to be used in an embodiment of the invention to facilitate event management. The collection 321 of auxiliary data structures preferably includes a wait event, 323, such as to inform the network connection manager 207 whether a particular queued event remains of interest to some entity or process. The collection 321 of auxiliary data structures further preferably includes a synchronization object, such as a WINDOWS event (e.g. a thread create/request event) within the WINDOWS brand operating system by MICROSOFT, for scheduling a thread 317 to service the queued events in the event queue 311.

As noted above, a preferred embodiment of the invention utilizes a single thread to service the event queue 311, but in alternative embodiments multiple threads may be used as long as there is a relatively small finite thread limit. For example, the number of threads may be limited to three threads. In particular, although the number of threads will in reality be limited in every case due to the finite amount of resources allocatable to threads, this type of limit does not prevent harmful and wasteful thread proliferation. Rather, the number of threads should be expressly limited to a small number that is substantially less than the theoretical limiting number of threads possible on a given architecture. In an embodiment of the invention, a thread limit 327 is provided as one of the collection 321 of auxiliary data structures, whereby the number of threads usable to service the events in the event queue 311 is not permitted to exceed this preset limit. In cooperation with the thread limit 327, a current thread count 329 is preferably also maintained within the collection 321 of auxiliary data structures, in order that the network manager 207 may determine whether the creation of another thread 317 is permissible at any given point in time.

Because the event queue 311 may in some cases be deconstructed before it is empty, a shutdown handle 331 is preferably provided to aid in speedy destruction of the queue 311. The termination of the network connection manager 207 for example, creates a situation wherein the queue 311 will no longer be used and should be deconstructed as soon as possible. Finally, a dispatch events flag 333 within the collection 321 of auxiliary constructions can be used by the network connection manager 207 in an embodiment of the invention to determine whether a thread for handling queue events has already been scheduled as will be discussed in greater detail below. This may be especially important when the thread limit is one. Note that the data structures 323-333 shown as part of the collection 321 are exemplary only and that some or all of these structures may be omitted or replaced in embodiments of the invention. For example, the dispatch events flag 333 may be used in one embodiment of the invention while the thread limit 327 and current thread count 329 may be used in another. Accordingly, none of the illustrated structures is required for each and every embodiment of the invention.

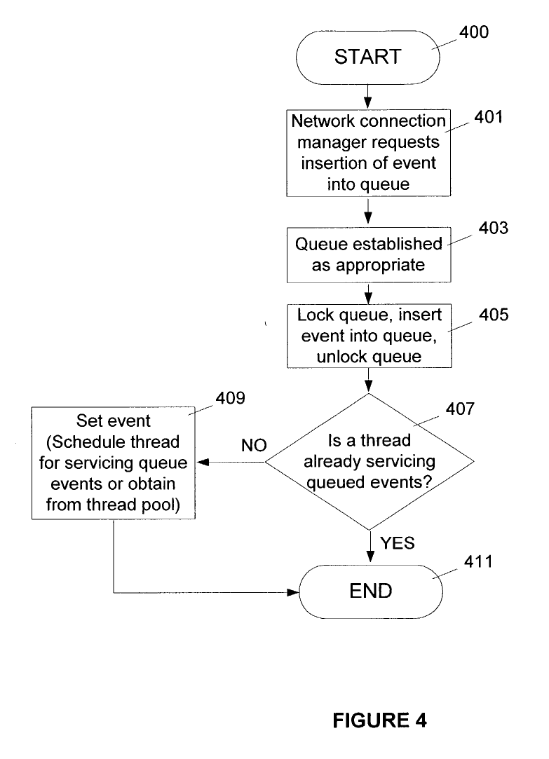

Having described the primary components and structures of the system according to an embodiment of the invention, the interoperation of various of these components and structures will be described more fully hereinafter by reference to FIGS. 4-6. FIG. 4 shows a flow chart setting forth steps usable within an embodiment of the invention to populate the event queue 311. The process begins from start node 400. At step 401, the network connection manager 207 issues a request, such as by a call to a queuing function, to insert an event into the queue 311. If the queue 311 has not yet been established, then it is instantiated at step 403 prior to any attempt to insert an event therein. If the request of the network connection manager 207 is successfully acted upon, then in step 405 the request results in the locking of the queue 311, insertion into the queue 311 of an appropriate event, and unlocking of the queue 311. For example, if a user accidentally physically disconnects a network connection such as by tripping over it, NDIS will send a media disconnect message to the network manager 207, which will then set an event and add the item to the queue 311 as described above.

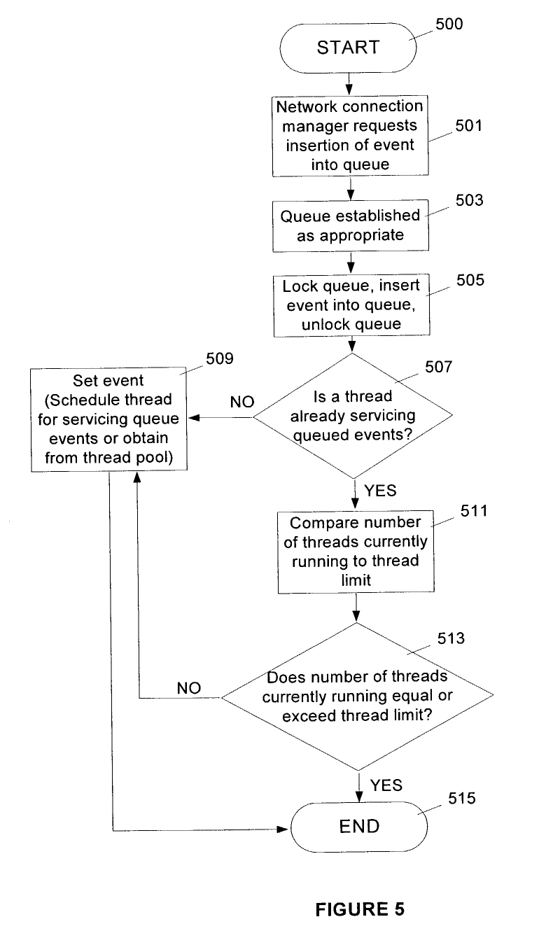

With the establishment of a queue 311 having at least one pending event therein, event servicing may commence. At step 407, it is determined whether an event is already set, i.e. whether an event thread, such as thread 317, is already running, servicing the queue events. This step may be executed either by comparing the current number of threads running to the thread limit as will be discussed in greater detail with respect to FIG. 5 below, or rather through the use of an interlocked exchange. The use of an interlocked exchange may be familiar to those of skill in the art, but will be described briefly herein for the reader's convenience. A flag, such as the DispatchEvents flag 333, is set, such as to zero, upon successfully starting a thread to service queued events, and is cleared upon completion of the thread. While the flag is set to zero, any other attempt to start a thread to service the queue will be void Once the flag has been cleared (set to one) another thread may be started.

Since the thread limit is one in the embodiment illustrated in FIG. 4, if such a thread is determined to be already running at step 407, then the process finishes at terminator 411. If instead it is determined at step 407 that an event thread is not already running, servicing the queue events, then at step 409 an event is set, i.e. a thread for servicing the queue events is scheduled or obtained from the thread pool, after which the process terminates at terminator 411. As discussed, the set event may be any suitable event type such as a WINDOWS event within the WINDOWS brand operating system by MICROSOFT. Note that as part of step 409, the status of the thread may be stored, such as by setting a flag or storing a count value.

FIG. 5 shows a flow chart setting forth steps usable within an embodiment of the invention to populate the event queue 311, wherein a non-unity thread limit is employed. The process begins at start node 500. Steps 501-505 correspond to steps 401-405. That is, at step 501, the network connection manager 207 issues a request to insert an event into the queue 311. If the queue 311 has not yet been established, then it is instantiated at step 503 after which the request results in step 505 in locking of the queue 311, insertion into the queue 311 of an appropriate event, and unlocking of the queue 311.

At step 507, it is determined whether an event thread is already running, servicing the queue events. If no such thread is running, then the process flows to step 509, wherein an event is set, i.e. a thread for servicing the queue events is scheduled, after which the process terminates at terminator 515. Note that as part of step 509 the status of the thread as running may be stored, such as by setting a flag to one or zero, or by storing a count value, such as one.

If instead it is determined at step 507 that an event thread is already running, servicing the queue events, then at step 511, the number of threads currently running is compared to a preset limit on the number of threads that may be used to service queued events at any one time. The number of threads running may be stored, such as in structure 329 of FIG. 3C, and may be retrieved in step 511 or earlier to effect the appropriate determination. Similarly, the preset limit on the number of threads may be stored, such as in structure 327 of FIG. 3C, and retrieved as needed.

If it is determined at step 513 that the number of threads currently running equals or exceeds the preset thread limit, then the process terminates at step 515 without the creation of another thread. Note that if the flow chart is followed closely, there should never be a case where the number of threads currently running exceeds the preset thread limit. However, variations introduced into the technique or environmental differences could create such a situation. There may be consequences related to exceeding the thread limit as well, but there is no limitation or requirement as to such within the invention.

If it is determined at step 513 that the number of threads currently running does not equal or exceed the preset thread limit, the process flows from step 513 back to step 509, causing another thread to be scheduled for handling queued events. It can be seen that whether a single thread is utilized to handle queued events as shown in the process of FIG. 4, or rather a small limited number of threads, as shown in the process of FIG. 5, excessive thread proliferation is precluded, thus saving machine resources and avoiding unnecessary termination of any process.

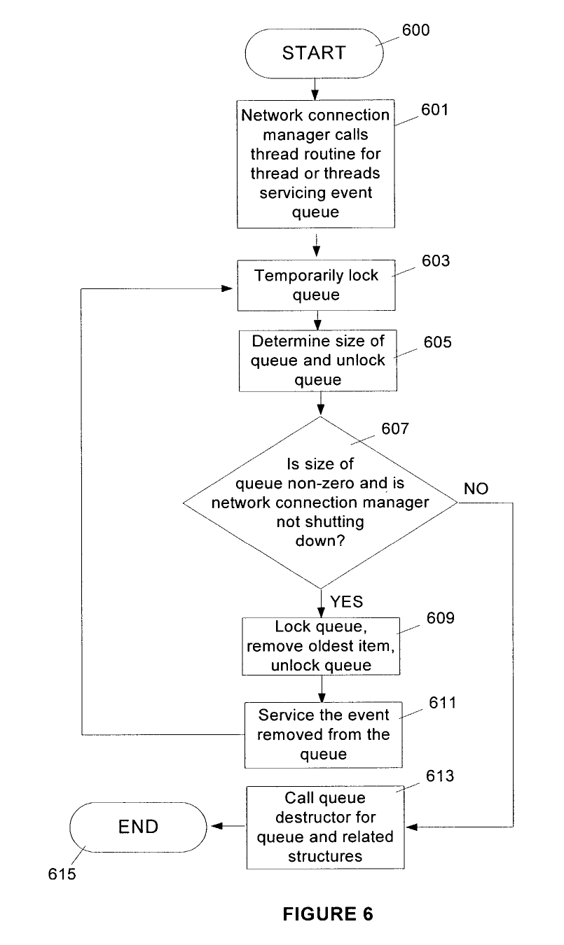

A process for dispatching events from the queue 311 according to an embodiment of the invention will be described hereinafter by reference to the flow chart of FIG. 6. The initial condition of the event queue 311 at the start of the process described by FIG. 6 is that the queue 311 contains at least one event waiting to be dispatched. The queue event dispatch process begins at start node 600. At step 601, the network connection manager 207 calls a worker function or thread routine, such as a DispatchEvents function for the thread or threads servicing the event queue 311. At step 603, the queue is temporarily locked so that no events will be inserted into or removed from the queue. In this manner, an accurate assessment of the state of the queue 311 may be made without the danger that the queue state will change during the assessment. While the queue 311 is locked, the size of the queue 311 is determined at step 605, generating an indication of the number of events waiting in the queue 311 to be serviced.

After the size of the queue 311 is determined at step 605, the queue is unlocked so that new events may be inserted into the queue and existing events may be deleted from the queue. Subsequently at decision 607, it is determined whether the size of the queue 311 is non-zero (i.e. one or more queued events await servicing) and whether the network connection manager 207 is not shutting down. If it is concluded at step 607 that the size of the queue 311 is non-zero and that the network connection manager 207 is not shutting down, then at step 609 the queue 311 is again locked, the oldest item in the queue 311 is removed (according to a first-in, first-out servicing order), and the queue 311 is again unlocked.

At step 611, the item removed from the queue 311 is serviced. In particular, a function to service the event is called, and work item data corresponding to the event removed from the queue 311 is passed in to the function, resulting in the servicing of the event and the propagation of the appropriate results or notices. From this step, the process loops back to step 603 and the steps that logically follow thereafter in order to service any remaining events in the queue 311. Note that in a system utilizing a non-unity thread limit, a subsequent execution of step 611 need not in every case await the completion of a prior execution of step 611. It can be seen that the processing loop between steps 611 and 603 continues until the queue 311 is empty or until the dispatching of events is terminated due to service shutdown.

If any execution of step 607 yields a determination that either the queue size is zero or the network connection manager 207 is shutting down, then the process flows to step 613 for completion. At step 613, a queue destructor is called for clearing the memory used by the queue and its related structures, after which the process ends at terminator 615. Note that the queue destructor may use the shutdown handle 331 of auxiliary structure 321 to expedite queue destruction. The step of calling the queue destructor may be especially significant when the service host itself is not shutting down, since in that case there may be no other mechanism for assuring proper destruction of the queue to free the memory occupied by the queue and its related structures. As discussed above, failure to properly free the memory may result in the termination or erroneous operation of another process. As part of the queue destruction process, the thread or threads servicing the queue 311 can be returned to the thread pool if appropriate to allow their further use by other functions.

A novel approach to event management has been described herein. The approach avoids thread proliferation while assuring appropriate servicing of events via an event queue serviced by a single thread or, in an embodiment of the invention, by a limited plurality of threads. It will be appreciated that the described techniques may be applied to the management of events of any type, and as such they are not limited to use in managing network events.

All of the references cited herein, including patents, patent applications, and publications, are hereby incorporated in their entireties by reference. That is, each and every part of every such reference is considered to be part of this disclosure, and therefore no part of any such reference is excluded by this statement or by any other statement in this disclosure from being a part of this disclosure.

In view of the many possible embodiments to which the principles of this invention may be applied, it should be recognized that the embodiments described herein with respect to the drawing figures are meant to be illustrative only and should not be taken as limiting the scope of invention. For example, those of skill in the art will recognize that the elements of the illustrated embodiments shown in software may be implemented in hardware and vice versa or that the illustrated embodiments can be modified in arrangement and detail without departing from the spirit of the invention. Furthermore, although network connections are illustrated herein as lines, no limitation should thereby be imparted to the invention. Network connections usable within embodiments of the invention may be circuit-switched, packet-switched, or otherwise, and may be transient or permanent, hard-wired or wireless, operating via any suitable protocol. Moreover, the exact values such as for thread counts given in the above description are exemplary only, and may be varied without departing from the scope of the invention. Therefore, the invention as described herein contemplates all such embodiments as may come within the scope of the following claims and equivalents thereof.

We claim:

1. A method of event management in a computing environment via an event queue comprising:
inserting an item into the event queue, wherein the item corresponds to an event to be serviced;
determining whether an event thread is running; and
if it is determined that an event thread is running, forgoing the instantiation of an event thread, and otherwise instantiating an event thread to service the item inserted into the event queue.

2. The method of event management according to claim 1, wherein determining whether an event thread is running comprises analyzing a flag to determine whether it is set.

3. The method of event management according to claim 1, wherein instantiating an event thread to service the item inserted into the event queue comprises setting a flag to indicate that the event thread has been instantiated.

4. The method of event management according to claim 1, wherein the event to be serviced is a network event associated with a network client.

5. The method of event management according to claim 1, wherein instantiating an event thread to service the item inserted into the event queue further comprises scheduling a new thread.

6. The method of event management according to claim 1, wherein instantiating an event thread to service the item inserted into the event queue further comprises obtaining a thread from a thread pool.

7. A method of managing events in a computing environment via an event queue comprising:
inserting an item into the event queue, wherein the item corresponds to an event to be serviced;
determining whether an event dispatch thread is running;
if it is determined that an event dispatch thread is not running, instantiating an event dispatch thread to service items of the event queue; and
if it is determined that an event dispatch thread is running:
determining a number of event dispatch threads currently running;
comparing the number of event dispatch threads currently running to a preset thread limit;
determining whether the number of event dispatch threads currently running equals or exceeds the preset thread limit; and
if the number of event dispatch threads currently running equals or exceeds the preset thread limit, forgoing the instantiation of an event dispatch thread, and otherwise instantiating an event dispatch thread to service items of the event queue.

8. The method of managing events according to claim 7, wherein the event to be serviced is a network event associated with a network client.

9. The method of managing events according to claim 7, wherein determining a number of event dispatch threads currently running further comprises inspecting a thread count field maintaining an indication of the number of event dispatch threads currently running.

10. The method of managing events according to claim 9, wherein instantiating an event dispatch thread to service items of the event queue further comprises augmenting the thread count value by one.

11. The method of managing events according to claim 7, wherein instantiating an event dispatch thread to service items of the event queue further comprises scheduling a new thread.

12. The method of managing events according to claim 7, wherein instantiating an event dispatch thread to service items of the event queue further comprises obtaining a thread from a thread pool.

13. A method of servicing an event comprising:
inserting an item into an event listing, wherein the item corresponds to the event, whereby the event listing contains an item corresponding to each of one or more events;
determining whether a thread for servicing any of the one or more events is running; and
starting a thread for servicing any of the one or more events it is determined that such a thread is not running, and otherwise not starting a thread for servicing any of the one or more events.

14. The method according to claim 13, further comprising servicing by the thread of the one or more items in the event listing in temporal order of insertion.

15. The method according to claim 14, further comprising establishing that there exist no more items in the event listing to be serviced, and thereafter destroying the event listing.

16. The method according to claim 13, wherein determining whether a thread for servicing any of the one or more events is running comprises analyzing a flag to determine whether it has been set, whereby if the flag has been set then such a thread is running.

17. The method according to claim 16, wherein starting a thread for servicing any of the one or more events comprises setting the flag to indicate that such a thread has been started.

18. The method according to claim 13, wherein starting a thread for servicing any of the one or more events further comprises obtaining a thread from a thread pool.

19. A method of servicing an event comprising:
placing an item into an event listing, wherein the item corresponds to an event to be serviced, and whereby the event listing contains an item corresponding to each of one or more events listed in their temporal order of insertion into the listing;
determining whether at least one thread for servicing any of the one or more events is running;
starting a thread for servicing any of the one or more events it is determined that at least one such thread is not running; and
if it is determined that at least one thread for servicing any of the one or more events is running:
determining a number of such threads currently running;
comparing the number of such threads currently running to a thread count maximum value, and thereby determining whether the number of such threads currently running equals or exceeds the thread count maximum value; and
if the number of such threads currently running equals or exceeds the thread count maximum value, forgoing starting another thread for servicing any of the one or more events, and otherwise starting a thread for servicing any of the one or more events.

20. The method according to claim 19, wherein determining a number of such threads currently running further comprises observing a thread count value indicating the number of such threads currently running.

21. The method of managing events according to claim 20, wherein starting a thread for servicing any of the one or more events further comprises increasing the thread count value.

22. The method according to claim 19, wherein starting a thread for servicing any of the one or more events further comprises reserving a thread from a thread pool.

23. A system for servicing events comprising:
an event queue comprising a listing of a plurality of events to be serviced; and
a single event handler thread for servicing the plurality of events one at a time.

24. The system according to claim 23, wherein the single event handler thread services the plurality of events in the temporal order that the events were inserted into the queue.

25. The system according to claim 23, further comprising a thread flag, whereby the thread flag is in a set condition while the single event handler thread is running and in an unset condition while the single event handler thread is not running, such that insertion of another event into the listing of the event queue causes the thread flag to be observed, thereby assuring that a further event handler thread is not started while the single event handler thread is running.

26. A computer-readable medium having thereon computer-readable instructions for performing a method of servicing an event, the method comprising:
placing an item into an event listing, wherein the item corresponds to an event to be serviced, and whereby the event listing contains an item corresponding to each of one or more events listed in their temporal order of insertion into the listing;
determining whether at least one thread for servicing any of the one or more events is running;
starting a thread for servicing any of the one or more events it is determined that at least one such thread is not running; and
if it is determined that at least one thread for servicing any of the one or more events is running:
determining a number of such threads currently running;
comparing the number of such threads currently running to a thread count maximum value, and thereby determining whether the number of such threads currently running equals or exceeds the thread count maximum value; and
if the number of such threads currently running equals or exceeds the thread count maximum value, forgoing starting another thread for servicing any of the one or more events, and otherwise starting a thread for servicing any of the one or more events.

27. The computer-readable medium according to claim 26, wherein starting a thread for servicing any of the one or more events further comprises increasing the thread count value.

28. A computer readable medium having thereon a data structure comprising:
an event queue field having stored therein an event queue comprising a listing of a plurality of events to be serviced; and
a thread structure corresponding to a single event handler thread for servicing the plurality of events one at a time.

29. The computer readable medium according to claim 28, further comprising a thread flag field having stored therein a thread flag, whereby the thread flag is in a set condition while the single event handler thread is running and in an unset condition while the single event handler thread is not running, such that insertion of another event into the listing of the event queue causes the thread flag to be observed, thereby assuring that a further event handler thread is not started while the single event handler thread is running.
